(19) United States
(12) Patent Application Publication
(10) Pub. No.: US 2005/0129461 A1
(43) Pub. Date: Jun. 16, 2005

(54) Two-part snap-together panel fastener

(76) Inventor: David J Bruno, Doylestown, PA (US)

Correspondence Address: GREGORY J. GORE, 70 WEST OAKLAND AVENUE, SUITE 316, DOYLESTOWN, PA, 18901, US

(21) Appl. No.: 10/503,628

(22) PCT Filed: Jan. 31, 2003
(86) PCT No.: PCT/US03/02703

Related U.S. Application Data
(60) Provisional application No. 60/354,920, filed on Feb. 11, 2002.

(51) Int. Cl. F16D 1/00

(52) U.S. Cl. 403/408.1; 411/352

(57) ABSTRACT

A two-part, snap-together captive panel fastener includes a ferrule portion and a screw sub-assembly which are attachable by snap fit. A locking mechanism prevents the unintended separation of the two components. The two-part structure of the present invention permits the ferrule which is preferably composed of a very hard and durable metal to be first wave-soldered to a printed circuit board with other elements of the board. Later, the screw sub-assembly can be snapped into the circuit board-mounted ferrule away for the harsh wave-soldering environment. The ferrule and screw retainer may further include cooperating outer flanges which captivate a pivoting structure such as a lever so that the panel fastener may not only be used to secure the attached panel to a sub-structure but may also affix other hardware to the panel.

The present application is related to provisional patent application Ser. No. 60/354,920 entitled “Two-Part Snap-Together Panel Fastener” filed on Feb. 11, 2002, priority from which is hereby claimed.

### FIELD OF THE INVENTION

The present invention relates to captive panel fasteners of the type having a retractable screw which is captive and extendable within a ferrule that attaches to a first panel. In fasteners of this type, the screw is usually held in its extended position by a spring but when depressed may be threaded into a second panel thereby joining the two panels.

### BACKGROUND OF THE INVENTION AND PRIOR ART

Panel fasteners are well known in the art and include different means of attaching the ferrule to the first panel. Both snap-in and clinch-fit means of attachment are employed. The screw may be captivated in the ferrule by different means, but the captivation means are usually permanent and thus the screw and spring assembly is not detachable once the assembly of parts is completed. Thus, all elements of the fastener assembly must be fixed to the panel at the same time and therefore all elements will experience the same environment in subsequent steps of the manufacturing process to which the greater assembly is subjected.

A problem exists, however, because this may not be desirable. The panel may be subjected to manufacturing environments such as excessive heat that is not compatible with the materials of the screw/spring assembly. By nature, the screw/spring sub-assembly of these fasteners includes more delicate structures which cannot survive many harsh manufacturing environments such as those experienced during circuit board manufacture. However, there is a need to have the panel fastener attachment occur during or prior to manufacturing steps such as wave soldering. Therefore, while a permanently assembled panel fastener has the advantage of the permanent retention of all components, it may not be suitable in all applications. There may also be other applications in which the panel fastener not only unites two panels, but is also required to support other structures. In these cases, some means for the attachment/detachment of those structures to the body of the panel fastener is also needed. In yet other applications, it may be desirable to have the panel fastener installed on the panel in stages where the ferrule is attached first and then the spring and screw assembly assembled at a later time at another location.

There is therefore a need in the art for a panel fastener assembly which will permit the ferrule portion to be attached to the base panel in a step separate from assembling the other components of the captive panel fastener. There is a further need for having the final assembly of parts to be quick and efficient without the need for special tools. And finally, there is a need for a captive panel fastener assembly which will accommodate the attachment of other structures to the panel without additional cost or complexity.

### SUMMARY OF THE INVENTION

The present invention has been devised to meet the needs in the art described above. The invention consists of a two-component, snap-together captive panel fastener in which the two components are individual sub-assemblies kept separate during different phases of the manufacturing operation. This is accomplished by a unique configuration of snap-together elements which includes a detachable ferrule portion and a snap-in screw/spring/retainer sub-assembly. The present invention's two-part system permits, for example, a separate ferrule of very hard and durable metal to be first wave-soldered to a printed circuit board with other elements of the board. Later, the screw sub-assembly can be snapped into the ferrule mounted on the circuit board when desired away from the harsh wave-soldering environment.

In another embodiment of the invention, the ferrule and the screw retainer include cooperating outer flanges which captivate a pivoting structure such as a lever so that the panel fastener may not only be used to secure the panel to a sub-structure, but may also be employed to affix other hardware. In one embodiment, a lever is fitted over the barrel of the ferrule and is retained against a bottom flange of the ferrule by a top flange of the screw/spring sub-assembly retainer. Sufficient snap force holding the two parts together is provided to withstand the forces of normal lever actuation.

More specifically, the applicant has invented a captive panel fastener assembly comprising a screw having an enlarged head, a shank, and a threaded portion of greater diameter than the shank. The fastener includes a retainer having a flange at the top, a bore receiving the screw, and a plurality of axially-extending resilient fingers at the bottom, the fingers each include an outward-facing barb and an inward-facing fingertip adjacent the shank when assembled. The diametric distance between the fingertips at rest is less than the diameter of the threaded portion of the screw but greater than the diameter of the shank. Spring means is operative between the screw head and the retainer flange to bias the screw in a retracted position. A ferrule includes a bore with an internal annular flange dimensioned to cooperate with the resilient retainer fingers by snap action whereby the barbs are forceably engaged with the internal flange to join the ferrule and the retainer. The ferrule further includes panel attachment means adjacent a bottom end and a second radially extending outer flange proximate the bottom end thereof. When applied, snap fingers and a solder joint rigidly attaches the ferrule to an aperture in the circuit board panel. The ferrule further includes a barrel portion located between the retainer flange and the second outer flange proximate the bottom end thereof. The fastener may also include a device that is captivated by the retainer flange and the ferrule outer flange whereby the device is attached to the panel. In one embodiment, the device is a lever rotatable about an outside surface of the barrel of the ferrule. Preferably, the retainer also includes a bottom-facing bevel on the inside surface of each fingertip. This provides a locking function since the threaded portion of the screw includes a downwardly-angled top land which engages the bevel upon upward retraction of the screw from the ferrule. Thus, if the screw is pulled away from the panel, the retainer fingers are forced outwardly against the internal flange of the ferrule preventing further retraction. The screw sub-assembly can only be released from the ferrule by first pushing in the screw while pulling on the retainer. Since this operation requires the application of forces to different parts of the assembly in different directions, inadvertent removal of the spring sub-assembly from the ferrule is avoided.

It is therefore an object of the invention to provide a panel fastener with a separatable spring/screw sub-assembly that may be pre-assembled away from the final assembly site. It is another object of the invention to provide an assembled panel fastener that may be accomplished quickly and efficiently without the need for special tools. It is yet another object of the present invention to provide a captive panel fastener assembly which will also secure other structures to the primary panel without additional cost or complexity. Other objects and advantages will become apparent from the following drawings and description of the preferred embodiment.

### BRIEF DESCRIPTION OF THE DRAWINGS

FIG. 1 is an exploded assembly view of the present invention.

FIG. 2 is an exploded assembly view of the screw/spring sub-assembly.

FIG. 3 is a side sectional view of the retainer of the spring screw sub-assembly.

FIG. 4 is a side sectional assembly view of the present invention.

FIG. 5 is a side sectional view of the ferrule element of the invention shown in isolation.

FIG. 6 is a side sectional view of the present invention in its fully assembled condition.

### DESCRIPTION OF THE PREFERRED EMBODIMENT

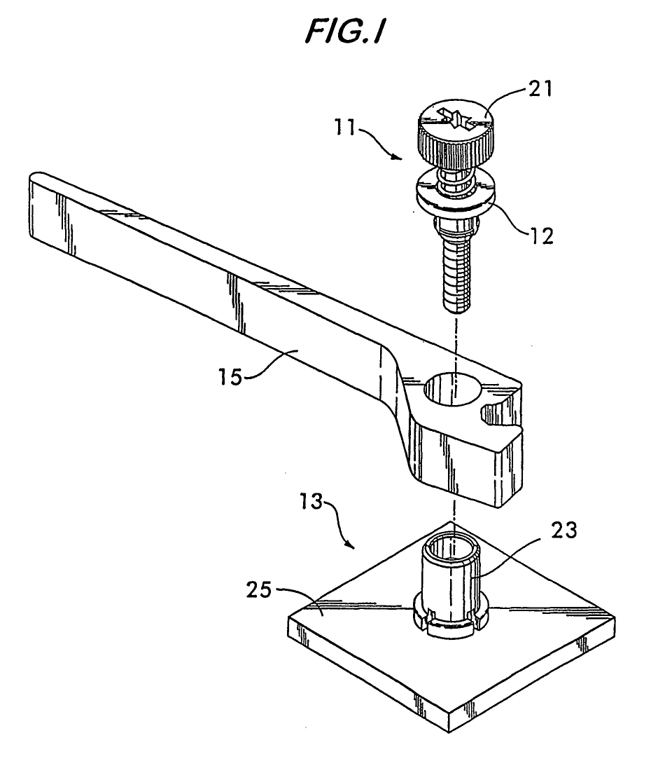

Referring now to FIG. 1, the present invention includes two major fastener sub-assemblies 11 and 13 snapped together to captivate lever 15 between cooperating flanges, one on each of the two inner fitting snap-together parts. The top part is a screw/spring sub-assembly 21 which includes a retainer 12 that snaps into the bore of the ferrule 23 that is pre-assembled to panel 25 in a separate assembly step. This sequence of assembly may take place as different events separated by time and distance as desired. For example, the assembly of the ferrule to the panel may take place during a wave-soldering process where it is not desirable to expose the other components to the heat and hazardous conditions in that manufacturing environment. As described further herein, the assembly of parts may support a rotatable element such as lever 15.

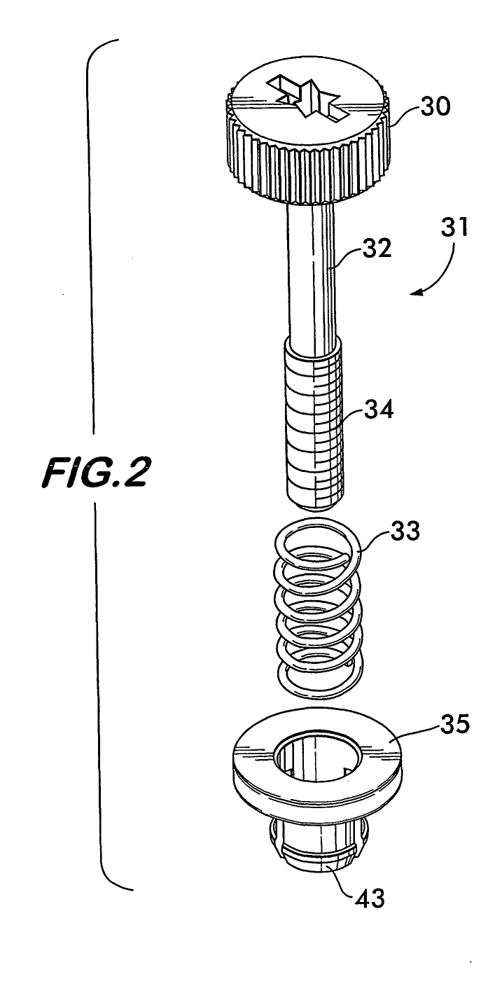

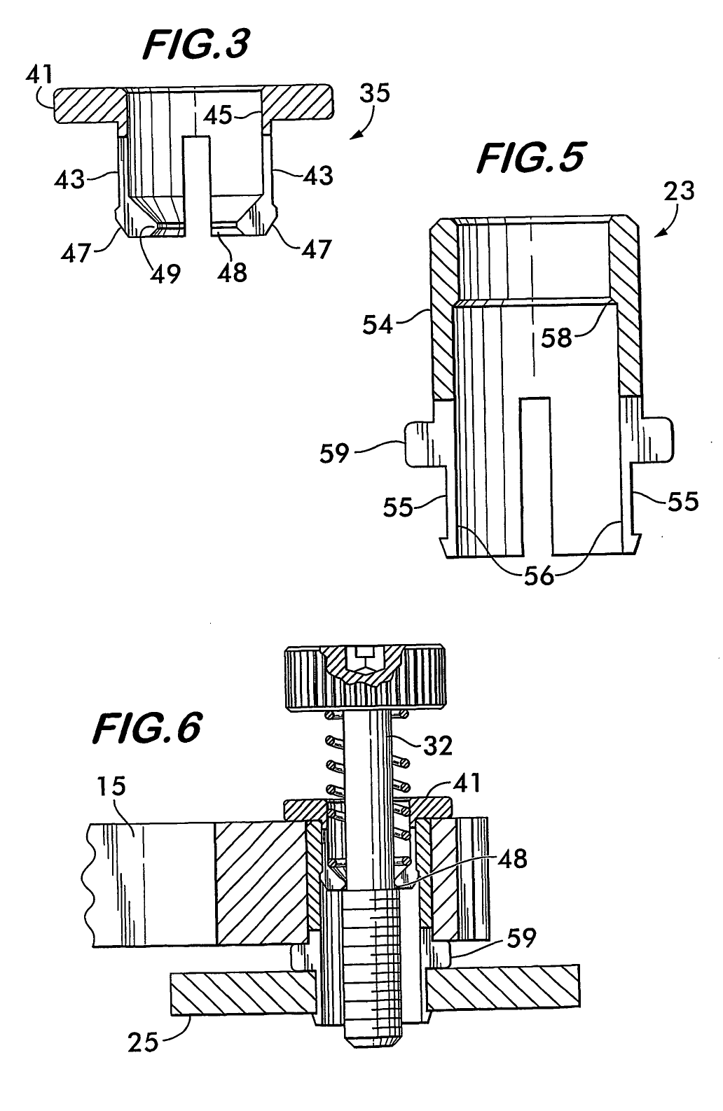

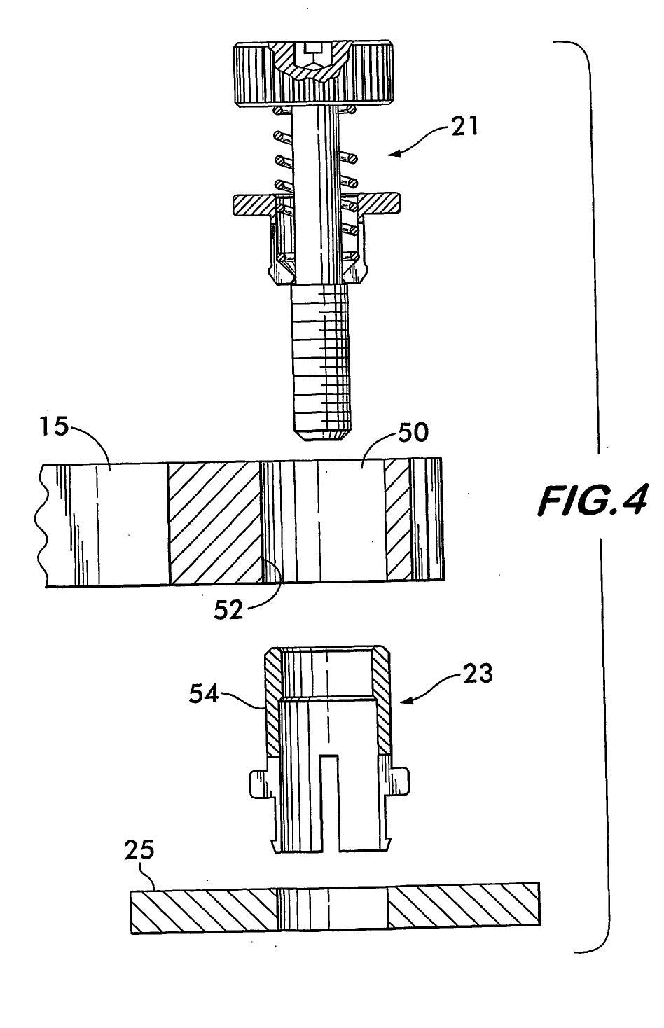

Referring now to FIGS. 2 and 3, an assembly view of the screw/spring sub-assembly is shown with screw 31 fitted inside of spring 33 and both parts fitted within the bore of retainer 35. The screw includes a head 30, a shank 32, and a threaded portion 34 of greater diameter than the shank. Snap fingers 43 extend axially from the base of the retainer. As more clearly shown in FIG. 3, the retainer includes a flange 41 with snap fingers 43 extending axially around the circumference of an internal bore 45. The ends of the snap fingers include external, outward-facing barbs 47 for snap-in engagement with an internal flange of the ferrule. Fingertips 49 are inward-facing to provide a bottom opening of reduced diameter about the central axis so that the smallest diameter between the snap fingers 42 is less than the major diameter of the threaded portion 34 of the screw but greater than the diameter of the screw shank 32. Therefore, when the screw is first pressed into the retainer, the fingertips 49 spread to allow passage of the threaded portion 34 and then they contract about shank 32. This operation slidably captivates the screw in the retainer by the inward-facing surfaces of the retainer snap fingers as shown in FIGS. 4 and 6. A bevel 48 is located around the inside edge of each of the fingertips 49. Bevel 48 contributes to a locking function of the fastener that will be more fully explained with regard to FIG. 6.

Referring now to FIG. 4, the assembly of parts of FIG. 1 is shown from a side view. The screw sub-assembly 21 is shown in alignment with lever 15, ferrule 23, and panel 25. The lever includes an aperture 50 having an inside wall 52 which is compatible with the outside diameter of the ferrule barrel 54 to provide an axle for the lever to pivot. Referring now to FIG. 5, the ferrule 23 further includes an area 56 of increased diameter along the bottom portion of its bore forming an internal annular flange 58. As more clearly shown in FIG. 6, the external barbs of the retainer snap fingers expand into this area against the flange 58 to form the snap-fit connection of the retainer into the ferrule. Outer flange 59 acts as a stop against the top side of the attached panel and also provides an abutment for the lever to space it away from the panel. The ferrule further includes snap-arms 55 to provide means for panel attachment.

Referring now to FIG. 6, all elements of the present invention are shown in their fully assembled condition. The lever 15 is comfortably received about the barrel of the ferrule and between the retainer flange 41 and the ferrule flange 59 so that the united parts form a rotatable attachment of the lever to panel 25. From this figure the importance of the radial bevel on the inside surface of the retainer snap fingertips can be appreciated. Since the screw in its retracted position places the screw threads against bevel 48, further retraction of the screw creates a wedge force between the land of the top thread and the face of the bevel pushing the snap fingers outwardly against the internal flange of the ferrule thus locking the retainer to the ferrule. Therefore, pulling on the head of the screw in a completed assembly as shown in this figure will not separate the parts until the pull-out force exceeds the pull-out limit of the ferrule/panel connection. It should also be understood by these mechanical relations that the same locking function provided by the screw, the retainer, and the ferrule is operative whether or not the panel fastener assembly stands alone or is fitted into other parts as shown in FIG. 6. For the sub-assembly to be removed from the ferrule, the screw must first be depressed downward until the smaller diameter of the screw shank 32 resides between the tips of the retainer snap fingers. When the screw is held in, the fingers are able to contract as the retainer is then pulled axially upward out of the ferrule. Because opposing dual actions are required, accidental or inadvertent disassembly of the parts is prevented. The assembly of parts shown in FIG. 6 may then, as a self-contained unit, be fastened to a chassis or other sub-structure (not shown) by depressing the screw downwardly and threading it into the sub-structure.

In this preferred embodiment, the panel is attached to the ferrule by snap-fit provided by snap-in fingers 55 which axially extend from the bottom of the ferrule. It should be understood, however, that other panel attachment means at the base of the ferrule may be employed. Furthermore, there may be other modifications, enhancements, or improvements to the described preferred embodiment without departing from the nature and scope of the invention which is to be determined only by the following claims and their legal equivalents.

1. A captive panel fastener assembly, comprising:
a screw having an enlarged head, a shank, and a threaded portion of greater diameter than the shank;
a retainer having a flange at the top, a bore receiving said screw, and a plurality of axially-extending resilient fingers at the bottom, said fingers each including an outward-facing barb and an inward-facing fingertip adjacent said shank, the diametric distance between said fingertips at rest being less than the diameter of said threaded portion of said screw but greater than the diameter of said shank;
spring means operative between said screw head and said retainer flange and being received at one end within a recess of said retainer; and
a ferrule having a bore with a first internal annular flange dimensioned to connect to said resilient retainer fingers by snap action whereby said barbs are forceably engaged with said first internal flange wherein the outside diameter of the ferrule is less than the diameter of the retainer flange.

2. The panel fastener of claim 1 wherein said ferrule further includes attachment means adjacent a bottom end thereof.

3. The panel fastener of claim 2 wherein said ferrule further includes a second radially extending outer flange proximate the bottom end thereof.

4. The panel fastener of claim 2 wherein said attachment means are snap fingers for engaging an aperture in a panel.

5. The panel fastener of claim 1 further including a bottom-facing bevel on the inside surface of said retainer fingertips.

6. The panel fastener of claim 5 wherein said threaded portion of said screw includes a top land which engages said bevel upon upward retraction of said screw from said ferrule whereby said retainer fingers are forced outwardly against said first internal annular flange of said ferrule preventing further retraction.

7. The panel fastener of claim 4 wherein said ferrule further includes a barrel portion located between said retainer flange and the second outer flange proximate the bottom end thereof.

8. An assembly of parts including the panel fastener of claim 7 and further including a device external to said ferrule and captivated between the retainer flange and the second ferrule outer flange whereby said device is attached to a panel.

9. The assembly of parts of claim 8 wherein said device is a lever rotatable about an outside surface of the barrel of said ferrule.

10. The panel fastener of claim 2 wherein said attachment means rigidly affixes said ferrule to a circuit board.

11. The panel fastener of claim 10 wherein said attachment means includes a solder joint.

12. The panel fastener of claim 8 wherein said panel is a circuit board.

13. A captive panel fastener assembly, comprising:
a screw having an enlarged head, a shank, and a threaded portion of greater diameter than the shank;
a retainer having a flange at the top, a bore receiving said screw, and a plurality of axially-extending resilient fingers at the bottom, said fingers each including an outward-facing barb and an inward-facing fingertip adjacent said shank, the diametric distance between said fingertips at rest being less than the diameter of said threaded portion of said screw but greater than the diameter of said shank and further including a bottom-facing bevel on the inside surface of said fingertips;
spring means operative between said screw head and said retainer flange and being received at one end within a recess of said retainer; and
a ferrule having a bore with a first internal annular flange dimensioned to connect to said resilient retainer fingers by snap action whereby said barbs are forceably engaged with said first internal flange wherein the outside diameter of the ferrule is less than the diameter of the retainer flange.
